(19) United States
(12) Patent Application Publication
(10) Pub. No.: US 2024/0257788 A1
(43) Pub. Date: Aug. 1, 2024

(54) ACOUSTIC AUGMENTATION OF MUSICAL INSTRUMENTS WITH AN END-PIN

(71) Applicant: Arizona Board of Regents on behalf of Arizona State University, Scottsdale, AZ (US)

(72) Inventor: Seth Thorn, Tempe, AZ (US)

(73) Assignee: Arizona Board of Regents on behalf of Arizona State University, Scottsdale, AZ (US)

(21) Appl. No.: 18/534,406

(22) Filed: Dec. 8, 2023

Related U.S. Application Data
(60) Provisional application No. 63/442,291, filed on Jan. 31, 2023.

(51) Int. Cl. G10D 3/01

(52) U.S. Cl. CPC G10D 3/01

(57) ABSTRACT

Disclosed herein are compositions and methods for actuating stringed instruments. In embodiments, the compositions and methods are non-invasive and are used with stringed instruments that contain end-pins.

### CROSS-REFERENCE TO RELATED APPLICATION

This application claims priority to, and the benefit of, U.S. Provisional Patent Application Ser. No. 63/442,291 entitled “ACOUSTIC AUGMENTATION OF MUSICAL INSTRUMENTS WITH AN END-PIN” filed on Jan. 31, 2023. The content of the foregoing application is hereby incorporated by reference (except for any subject matter disclaimers or disavowals, and except to the extent of any conflict with the disclosure of the present application, in which case the disclosure of the present application shall control).

### TECHNICAL FIELD

The present disclosure relates to composition and methods for actuation of stringed instruments.

### BACKGROUND

Prior technologies have been developed that allow for actuation of stringed instruments using an actuator assembly. However, the structure of the current devices on the market require the ability to insert a large magnet assembly into the instrument in order to anchor the device against the backside of the instrument. Moreover, the backside of the instrument must be flat. Therefore, the device cannot be used with violins, violas, cellos, basses, or any traditional stringed instrument with a curved back or with any other instrument in which it would be difficult or impossible to reach into the instrument and attach the magnet assembly. No technique or technology currently exists for non-invasively actuating stringed instruments. Described herein are embodiments for non-invasively actuating stringed instruments.

### SUMMARY

In an aspect, a kit is provided, comprising an actuator; and at least one thumbscrew assembly, at least one clip, or at least one clamp, wherein the at least one thumbscrew assembly, the at least one clip, or the at least one clamp is configured to secure the actuator against an end-pin of an upright musical instrument. In embodiments, the kit further comprises the end-pin of the upright musical instrument.

In embodiments, the kit further comprises a grommet configured to be inserted into a hollow center of the actuator. In embodiments, the grommet comprises a lip that protrudes from the bottom of the grommet that is configured to cover a portion of the actuator.

In some embodiments, the at least one clamp comprises at least one strut-mount clamp.

In embodiments, the at least one thumbscrew assembly comprises at least two thumbscrew assemblies. In embodiments, the at least one thumbscrew assembly comprises at least two thumbscrew assemblies and each thumbscrew assembly comprises a hollow portion of a different diameter.

In embodiments, the at least one thumbscrew assembly comprises a hollow portion configured to allow insertion of the end-pin into the at least one thumbscrew assembly. In embodiments, the thumbscrew assembly functions to secure the actuator to the end-pin. In embodiments, the at least one thumbscrew assembly comprises a hollow portion, wherein the hollow portion is configured to allow insertion into the at least one thumbscrew assembly.

In an aspect, a composition is provided, comprising an end-pin of an upright musical instrument; and an actuator, wherein the end-pin is in contact with the actuator.

In embodiments, the composition further comprises at least one thumbscrew assembly, at least one clip, or at least one clamp that secures the end-pin to the actuator.

In embodiments, the at least one clamp comprises a strut-mount clamp.

In embodiments, the end-pin is in contact with the actuator via threading the end-pin through a hollow center of the actuator.

In embodiments, the composition further comprises a grommet inserted into the hollow center of the actuator, wherein the grommet is configured to prevent vibration or rattling of the end-pin against the actuator. In embodiments, the grommet comprises a lip that protrudes from a lower portion of the grommet that covers a portion of the actuator.

In embodiments, the actuator is contained within an enclosed structure and the at least one thumbscrew assembly, the at least one clip, or the at least one clamp secures the end-pin to the actuator via securing the enclosed structure to the end-pin.

In embodiments, the actuator is between an upper portion of the end-pin and the at least one thumbscrew assembly.

In embodiments, the at least one thumbscrew assembly comprises a first thumbscrew assembly and a second thumbscrew assembly, wherein the actuator is between the first thumbscrew assembly and the second thumbscrew assembly.

In embodiments, the end-pin is permanently affixed to the actuator.

In an aspect, a method of actuating an upright musical instrument is provided, comprising connecting an end-pin of the upright musical instrument to an actuator.

In embodiments, the end-pin is connected to the actuator using a thumbscrew assembly, clip, or a clamp. In embodiments, the end-pin is connected to the actuator via threading the end-pin through a hollow center of the actuator.

In embodiments, the thumbscrew assembly comprises a hollow portion, wherein the end-pin is connected to the thumbscrew assembly through insertion of the end-pin into the hollow portion of the thumbscrew assembly.

In embodiments, the clamp comprises a strut-mount clamp.

In embodiments, the end-pin is connected to the thumbscrew assembly through threading the end-pin through a hollow portion of the thumbscrew assembly.

In embodiments, connecting the end-pin to the actuator results in permanently affixing the actuator to the end-pin.

It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described herein.

### BRIEF DESCRIPTION OF THE DRAWINGS

With reference to the following description and accompany drawings:

FIG. 1 illustrates a depiction of end-pin assembly of a cello or upright bass, in accordance with an exemplary embodiment.

FIG. 2 illustrates an actuator with a hollow center, in accordance with an exemplary embodiment.

FIG. 3 illustrates a rubber grommet that can be inserted into an actuator, in accordance with an exemplary embodiment.

FIG. 4 illustrates a thumbscrew assembly that anchors an actuator assembly, in accordance with an exemplary embodiment.

FIG. 5 illustrates a rubber grommet that is inserted into an actuator, in accordance with an exemplary embodiment.

FIG. 6 illustrates a depiction of end-pin assembly of a cell or upright bass, with an end-pin extended and threaded through an actuator and a thumbscrew assembly, in accordance with an exemplary embodiment.

FIG. 7 illustrates a depiction of an end-pin, an actuator, and a long thumbscrew assembly, in accordance with an exemplary embodiment.

FIG. 8 illustrates a depiction of a body (e.g., a metal body) connected to a clamp (e.g., a strut-mount clamp), in accordance with an exemplary embodiment.

FIG. 9 illustrates a depiction of an end-pin of cello or bass that is connected to a body (e.g., a metal body) using a clamp (e.g., a strut-mount clamp), in which the clamp is in the open position, in accordance with an exemplary embodiment.

FIGS. 10 and 11 illustrate a depiction of an end-pin or a cello or bass that that is connected to a body (e.g., a metal body) using a clamp (e.g., a strut-mount clamp), in which the clamp is in the closed position, in accordance with an exemplary embodiment.

FIGS. 12A-12C illustrate an actuator that is permanently affixed to an end-pin rod, in accordance with an exemplary embodiment.

FIGS. 13A-13C illustrate an actuator that is secured to an end-pin rod using a thumbscrew assembly, in accordance with an exemplary embodiment.

FIGS. 14A-14C illustrate a strut-mount clamp connected to a metal body, in which the strut-mount clamp secures an actuator to an end-pin rod, in accordance with an exemplary embodiment.

### DETAILED DESCRIPTION

In an aspect, a non-invasive way to actuate an upright musical instrument (e.g., cellos and upright basses) that has an end-pin is provided. In embodiments, an actuator is configured to couple to the end-pin such that vibrations from the actuator are transmitted to the instrument (i.e., cello or upright bass) body. In some embodiments, the actuator transmits vibrations through the end-pin rod. In embodiments, the system allows for traditional cellos and upright basses to be activated with digital signals without modifying or damaging the acoustic instrument. In embodiments, the actuator can be added or removed from a traditional instrument without damaging or modifying the instrument.

In embodiments, systems described herein provide a non-invasive way to acoustically actuate a musical instrument that has an end-pin, including cellos, upright basses, and other instruments. A sound capture device such as a microphone or pickup can be used to capture sound from the musical instrument. Digital signal processing on a computer or embedded audio device can then be used to apply reverb to the signal, echo, granulation, pitch-shifting, and/or other effects. This signal can then be fed into an amplifier that drives the actuator assembly that is attached to the end-pin. This results in the digital processing sound coming out of the body of the acoustic instrument due to the actuator. In embodiments, the system includes any of the kits or compositions described herein that contain actuators.

Embodiments described herein enable digital signal processing techniques to be used with new classes of instruments, for example, cellos and upright basses. In embodiments, an actuator with a hollow center is fitted with a custom rubber grommet that lets it easily slide onto the end-pin of a cello or upright bass. In some embodiments, the actuator is secured to the end-pin using a device such as a clip or a thumbscrew. In some embodiments, the actuator is secured to the end-pin using a clamp. In some embodiments, the clamp comprises a strut-mount clamp. In embodiments, a grommet to prevent the actuator from rattling against the end-pin when it is active and to keep it perpendicular to the end-pin. In embodiments, the musician slides the actuator onto the end-pin of the instrument, then slides a thumbscrew assembly onto the end-pin that secures the actuator against the bottom of the end-pin assembly. In embodiments, the musician attaches/secures the actuator to end-pin without sliding the actuator onto the end-pin. In some embodiments, the actuator is built into the end-pin, such that the actuator is a permanent feature of the end-pin.

In embodiments, some adjustment gives the actuator the right amount of play against the end-pin assembly of the instrument so that it actuates the instrument without rattling, but has enough contact to intensively actuate the acoustic body. In embodiments, the lip of the soft rubber grommet inserted into the actuator that protrudes from the bottom also facilitates this balance.

Embodiments described herein extend the performance possibilities for cellos and upright basses by giving these instruments active acoustic features generated from real-time digital signal processing and amplification. When used alongside active shoulder rests, an entire string orchestra can be augmented with digital feedback and electronic sound. This can extend the performance possibilities of cellos, upright basses, and other acoustic instruments that use an end-pin.

### Definitions

As used herein, the term “end-pin” refers to a component of a cello or upright bass that is extendible from the cello or upright bass, and that makes contact with the floor. An “end-pin” includes an “end-pin rod” that is secured to the cello. As used herein, the term “end-pin” and the term “end-pin assembly” have the same meaning and are used interchangeably herein.

As used herein, the term “end-pin rod” refers to a component of an “end-pin (“end-pin assembly),” which supports the weight of the cello or upright bass.

### Compositions

### Embodiment 1—Hollow Actuator that Slips Over and End-Pin

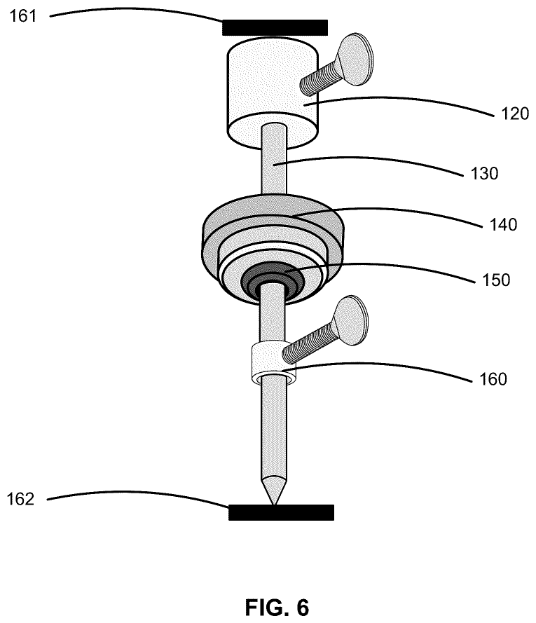

In an aspect, a composition is provided as depicted in the exemplary embodiment in FIG. 6. As shown in FIG. 6, the composition comprises an end-pin assembly 120 with the end-pin rod extended 130. In embodiments, the composition includes a hollow actuator 140 capable of slipping over an end-pin. In some embodiments, the hollow actuator 140 is placed anywhere on the extended end-pin 130. In some embodiments, the actuator is connected to a grommet 150. In some embodiments, the grommet comprises at least one lip that protrudes from the bottom of the grommet. In some embodiments, the at least one lip is configured to cover a portion of the actuator.

In some embodiments, the actuator is placed near the base of the instrument 161 on the extended end-pin. In some embodiments, the actuator is placed near the floor/ground 162 on the extended end-pin. In some embodiments, the actuator is placed on the extended end-pin anywhere between the base of the instrument 161 and the floor/ground 162. In some embodiments, the actuator is placed anywhere on the extended end-pin. In some embodiments, the actuator is secured into place on the extended end-pin using a thumbscrew assembly 160.

In some embodiments, the extended end-pin is threaded through an actuator. In some embodiments, the extended end-pin is threaded through an actuator 140 that has an appropriate grommet 150 inserted. In some embodiments, the end-pin is also threaded through a thumbscrew assembly 160 that secures the actuator.

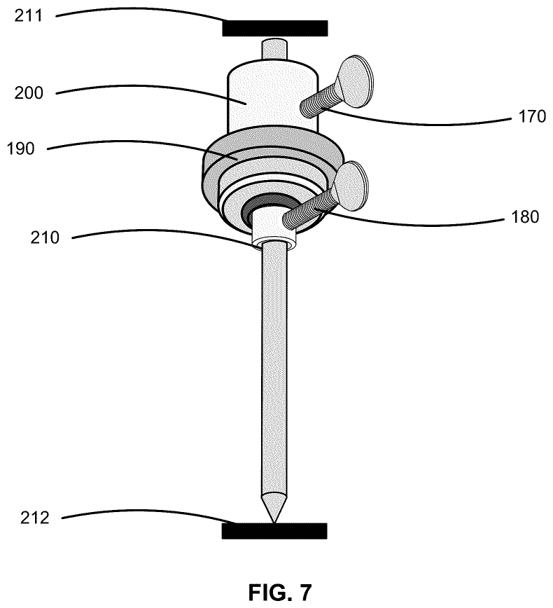

In embodiments, a composition is provided as depicted in the exemplary embodiment depicted in FIG. 7. As depicted in FIG. 7, the actuator 190 is hollow such that it slips over the end-pin. In some embodiments, the composition comprises long thumbscrews (thumbscrew assemblies) 170, 180 of varying diameters. In some embodiments, the composition comprises two thumbscrews (thumbscrew assemblies). In some embodiments, the hollow actuator 190 rests against the end-pin assembly 200 of the cello or upright bass, close to the base 211 of the cello or base. In an alternative embodiment, the actuator 190 rests against the end-pin assembly 200 close to the floor/surface 212. The hollow portion 210 of a thumbscrew (or thumbscrews) 180 can contain a diameter that is larger than the diameter of the actuator. The thumbscrew (or thumbscrews) 180 can secure the hollow actuator 190 in place against the end-pin.

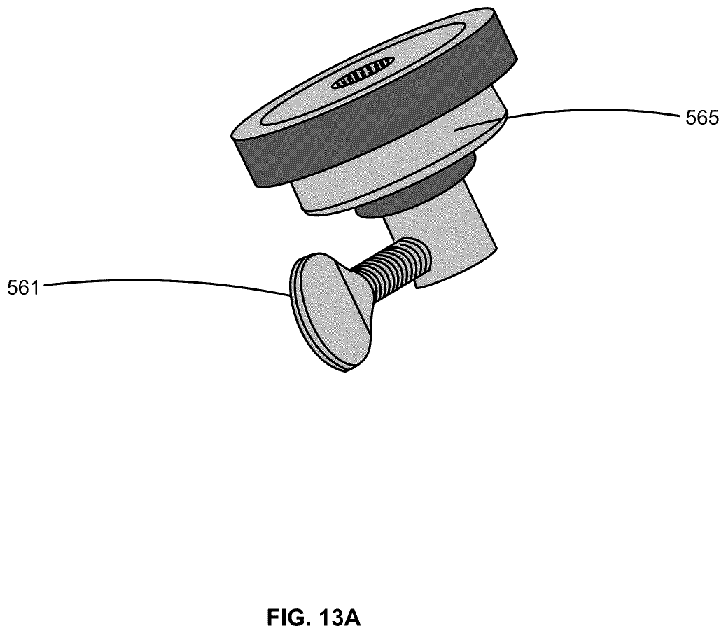

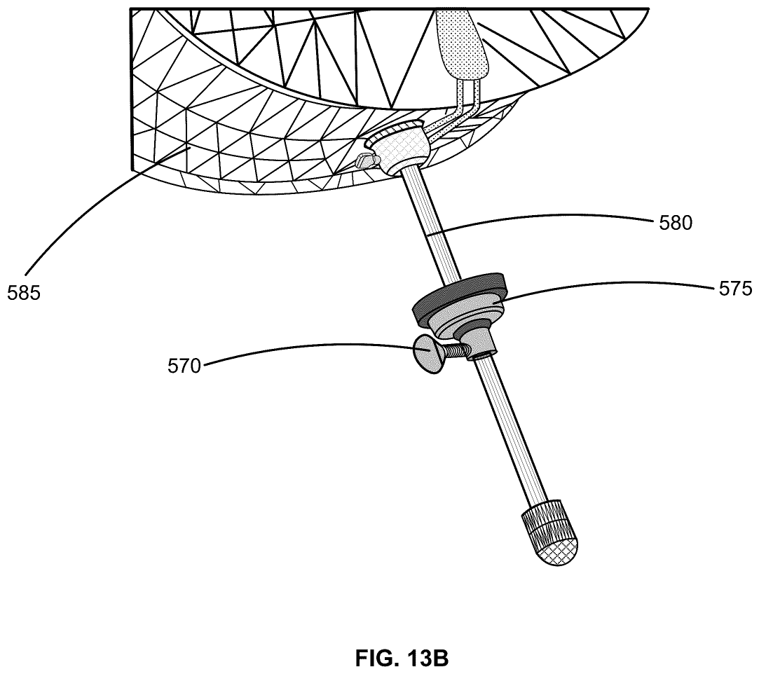

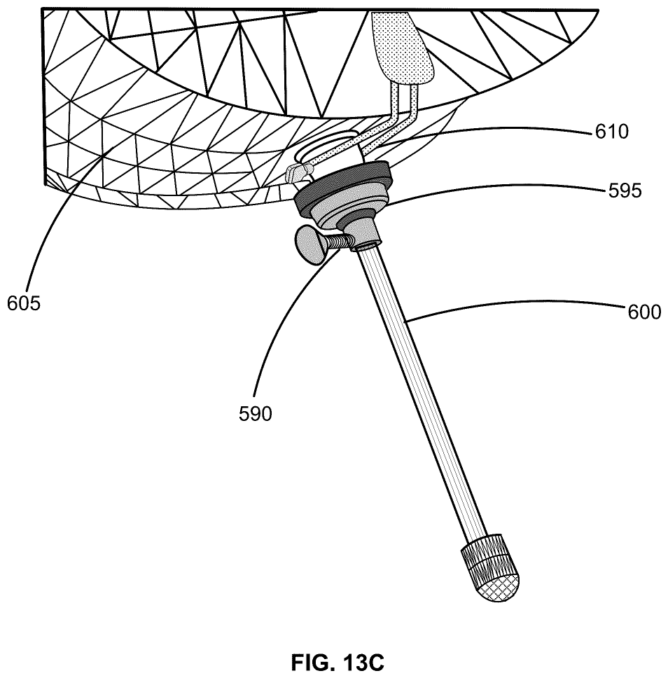

FIG. 13A provides an exemplary embodiment of a thumbscrew 561 inserted into a hollow actuator 565. FIG. 13B provides an exemplary embodiment of a thumbscrew 570 securing an actuator 575 to an end-pin rod 580 of a cello or upright bass 585. FIG. 13C provides an exemplary embodiment of a thumbscrew assembly 590 securing an actuator 595 to an end-pin rod 600 of a cello or upright bass 605, in which the actuator is touching the base 610 of the cello or upright bass.

### Embodiment 2—An Actuator Embedded in a Case that Clamps to the End-Pin Rod

In some embodiments, the actuator is contained within a case comprising an enclosed structure. In some embodiments, the case is secured to an end-pin rod using a clamp. In some embodiments, the case comprises material of any one or more of plastic, wood, or metal. In some embodiments, the enclosed structure comprises a body that is at least partially hollow. In some embodiments, the body of the enclosed structure contains an actuator. In some embodiments, the body of the enclosed structure contains other devices such as any one or more of a microcontroller with RF connectivity, a battery, switches for controlling the battery, a port for charging and/or updating firmware, and an inertial measuring unit.

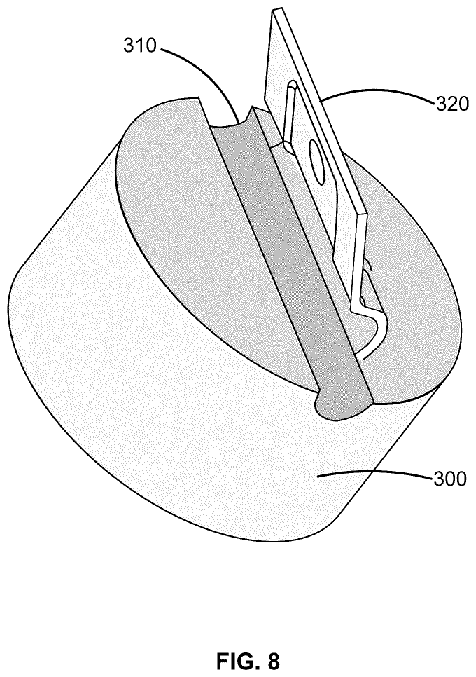

An exemplary embodiment of an enclosed structure with at least a partially hollow body 300 connected to a strut-mount clamp 320, is shown in FIG. 8. In some embodiments, the body contains a groove 310 into which an extended end-pin can be inserted. In some embodiments, the at least partially hollow body is made up of metal. In some embodiments, the at least partially hollow body contains an actuator. In some embodiments, the at least partially hollow body contains any one or more of a microcontroller with RF connectivity, a battery, switches for controlling the battery, a port for charging and/or updating firmware, and an inertial measuring unit.

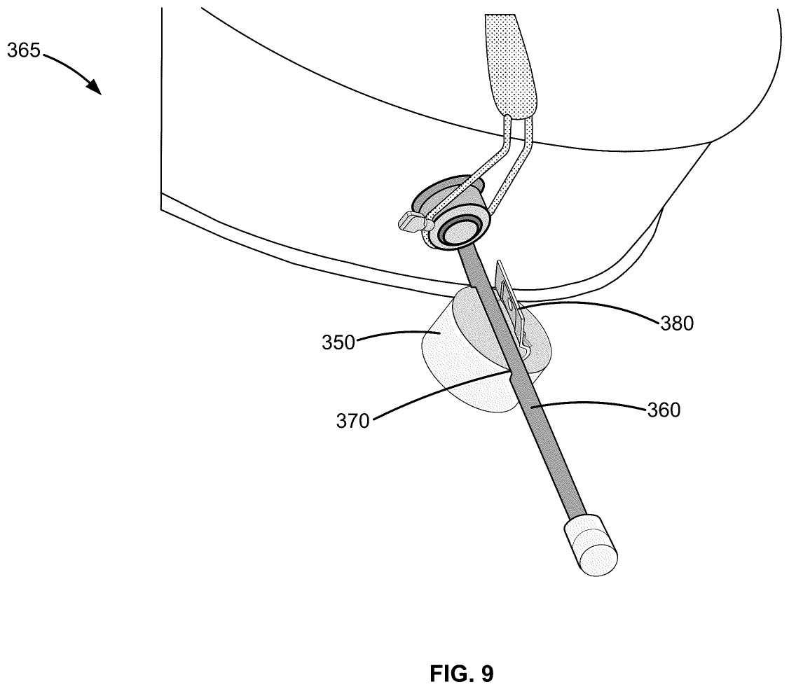

FIG. 9 depicts an exemplary embodiment of an at least partially hollow body 350 in which an extended end-pin 360 from a cello or upright bass 365 is inserted into a groove 370 of the body. In some embodiments, the body comprises a metal body. As further depicted in FIG. 9, a strut-mount clamp 380 is attached to the body 350. As depicted in FIG. 9, the strut-mount clamp is in the open position.

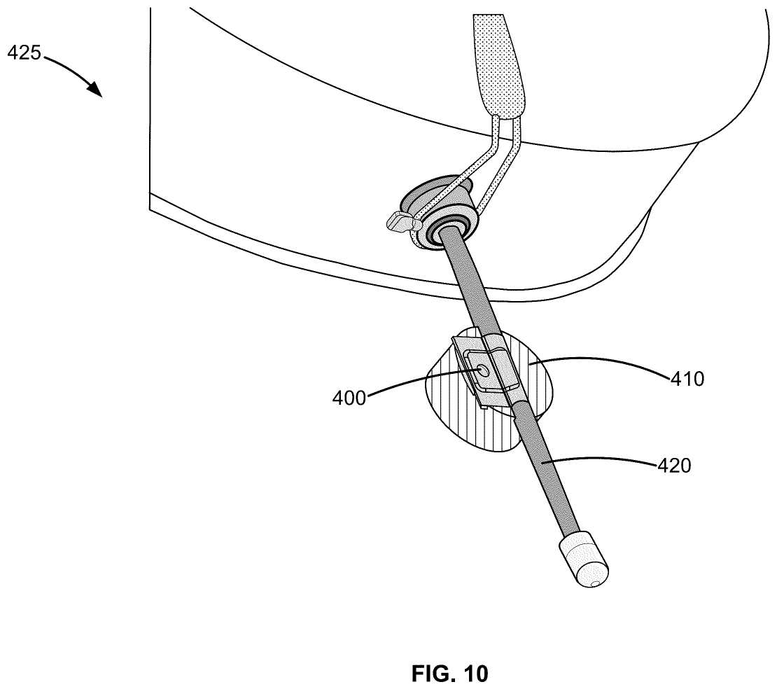

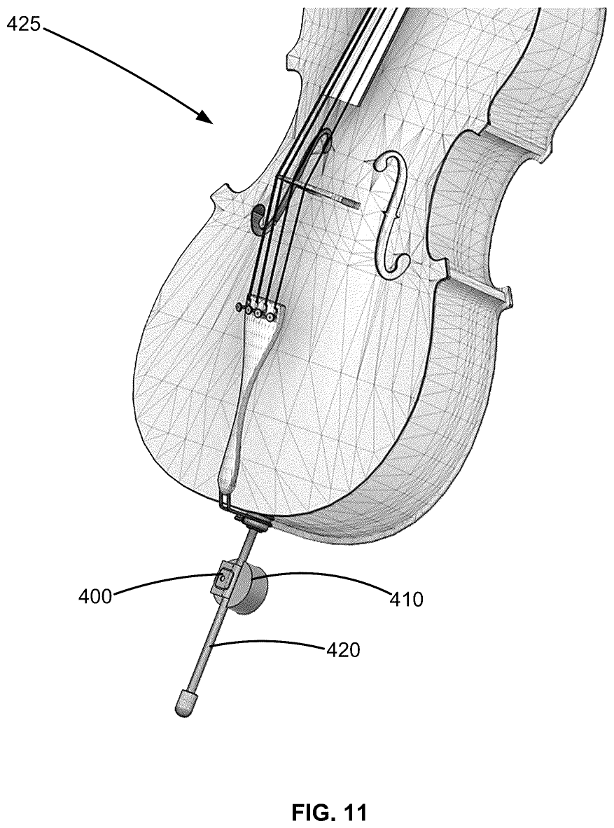

FIG. 10 depicts an exemplary embodiment of a strut-mount clamp 400 connected to a body 410, in which the strut-mount clamp is in the closed position. As shown in FIG. 10, the strut-mount clamp in the closed position secures the body 410 to the extended end-pin 420 of a cello or upright bass 425. In some embodiments, the body 410 comprises a metal body. In some embodiments, the body 410 depicted in FIG. 10 contains an actuator. In some embodiments, the body 410 contains any one or more of a microcontroller with RF connectivity, a battery, switches for controlling the battery, a port for charging and/or updating firmware, and an inertial measuring unit. FIG. 11 depicts an alternative view of FIG. 10 showing the cello/upright bass 425 that contains the extended end-pin 420 that is secured to the body 410 using the strut-mount clamp 400 in the closed position. In some embodiments, the strut-mount clamp secures the body to the extended end-pin using a tension lever or a spring-loaded lever. The strut mount clamp contains a groove 625 into which an end-pin rod can be inserted.

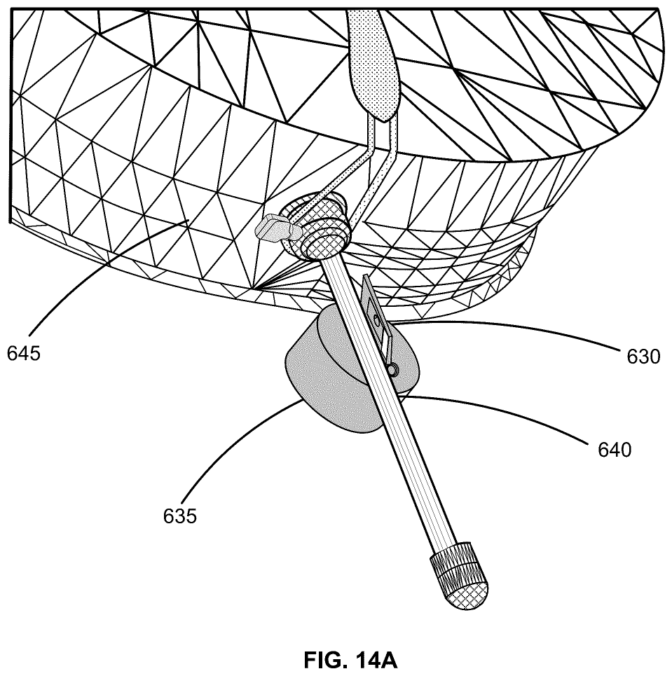

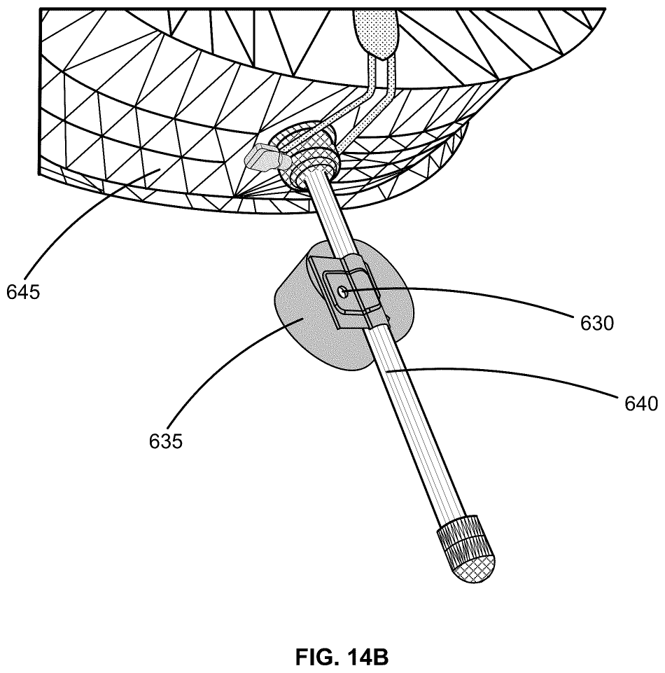

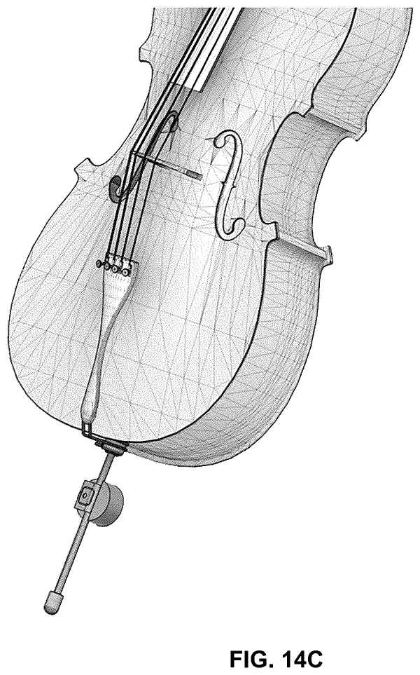

FIGS. 14A and 14B depict an exemplary embodiment of a strut-mount clamp 630 that is connected to a metal body 635 in which an end-pin rod 640 of a cello or upright bass 645 is inserted into a groove of the metal body. FIG. 14A depicts the strut-mount clamp an open position and FIG. 14B depicts the strut-mount clamp in the closed position. FIG. 14C depicts an alternative view of FIG. 14B.

### Embodiment 3—An Actuator Permanently Affixed to an End-Pin

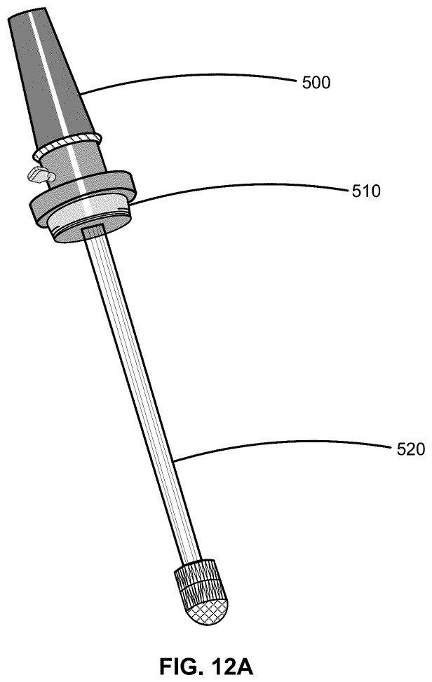

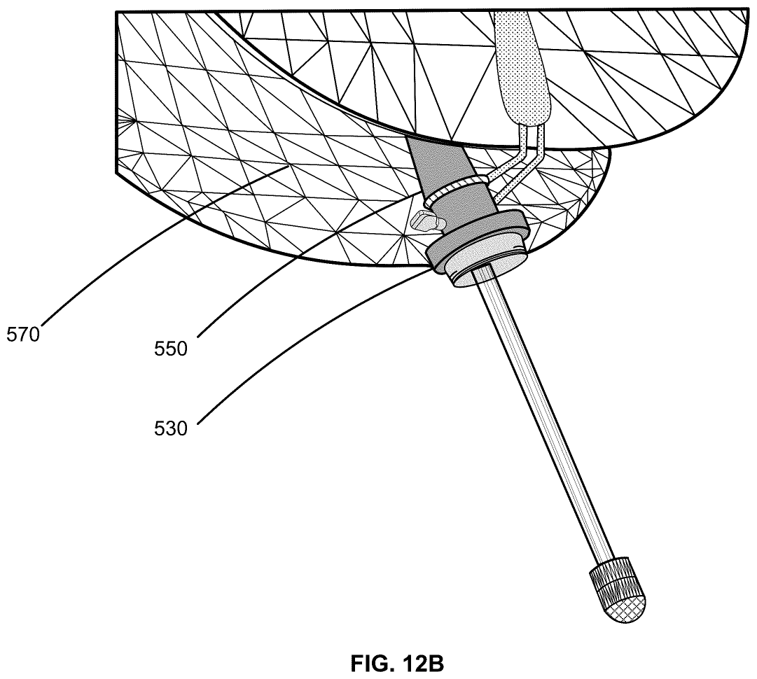

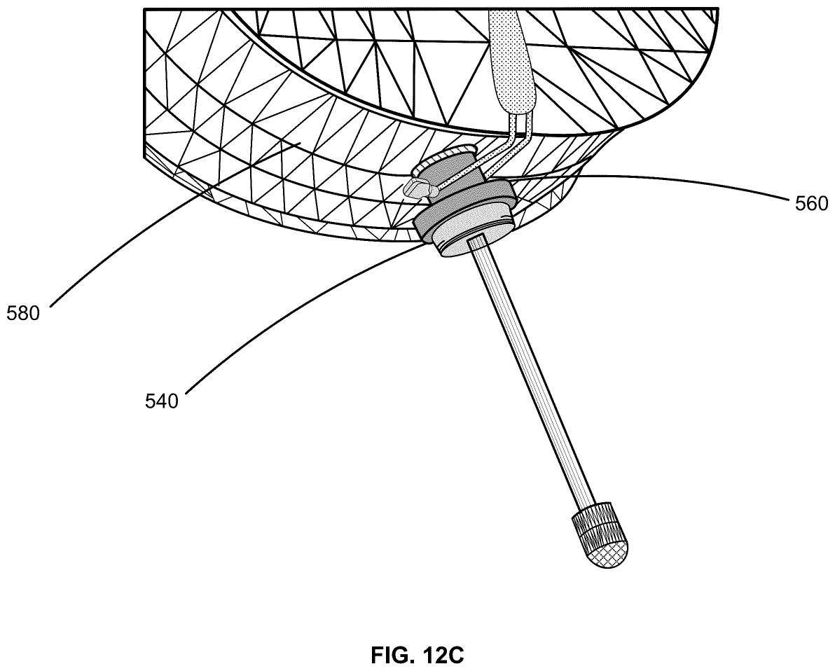

In an aspect a composition is provided comprising an actuator that is permanently affixed to an end-pin. FIG. 12A depicts an exemplary embodiment of an end-pin 500 in which an actuator 510 is permanently affixed to the end-pin rod 520. FIGS. 12B and 12C depict actuators 530 (FIG. 12B), 540 (FIG. 12C) permanently affixed to an end-pin 550 (FIG. 12B), 560 (FIG. 12C) that is attached to a cello or upright bass 570 (FIG. 12B), 580 (FIG. 12C).

### Additional Embodiments

In an aspect, a composition is provided comprising an end-pin of an upright musical instrument and an actuator secured to the end-pin. In some embodiments, the actuator is secured to the end-pin using a thumbscrew. In some embodiments, the actuator is secured to the end-pin using a clip. In some embodiments, the actuator is secured to the end-pin using any device capable of securing the actuator to the end-pin. In some embodiments, the actuator is permanently affixed to the end-pin.

In an aspect, a composition is provided comprising an end-pin of an upright musical instrument; an actuator comprising a hollow center, wherein the end-pin is threaded through the hollow center of the actuator, and at least one thumbscrew assembly comprising a hollow portion, wherein the end-pin is threaded through the hollow center of the at least one thumbscrew assembly.

### Kits

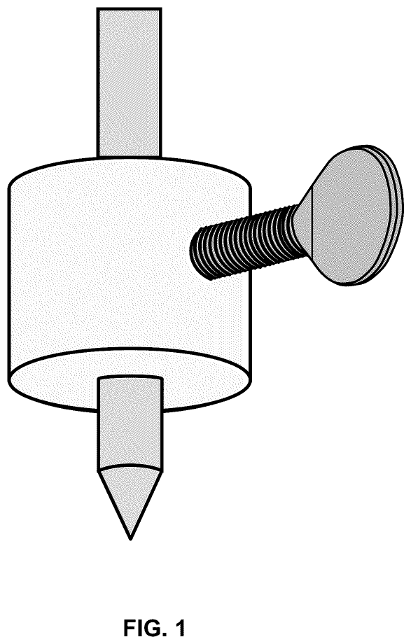

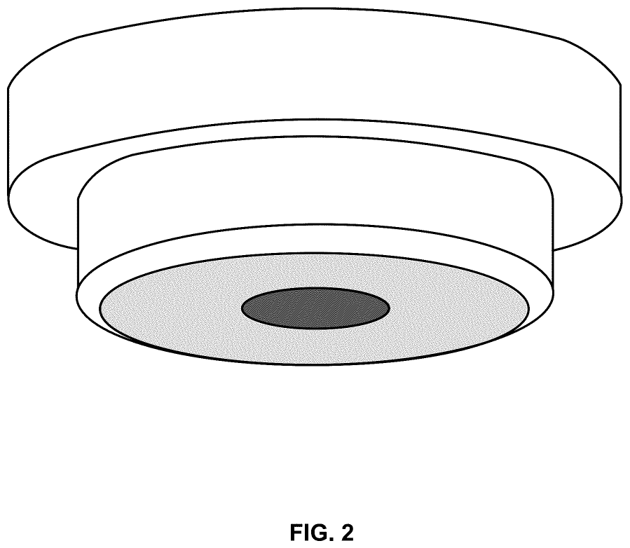

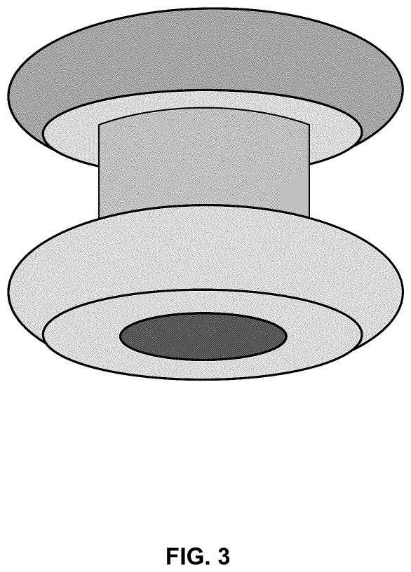

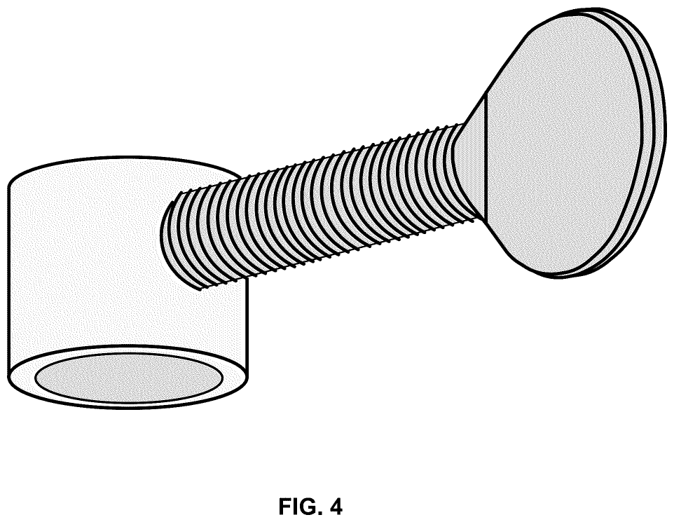

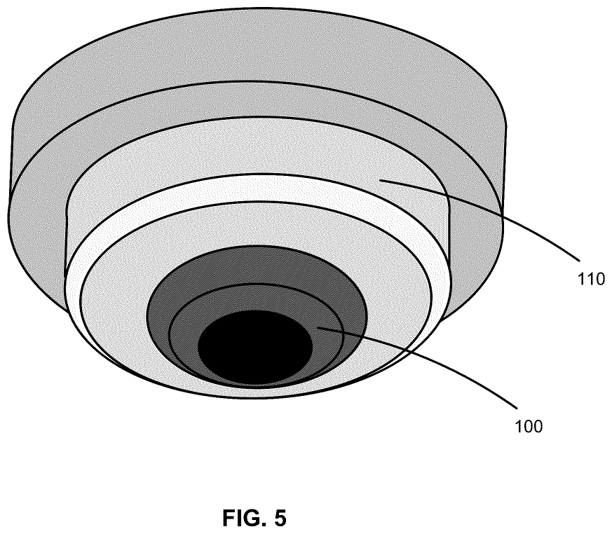

In an aspect, a kit is provided. In embodiments, the kit comprises an end-pin of a cello or upright bass, for example, the end-pin depicted in the exemplary embodiment in FIG. 1. In embodiments, the kit comprises an actuator with a hollow center, for example, the actuator depicted in the exemplary embodiment in FIG. 2. In embodiments, the kit comprises a grommet that is configured to be inserted into the actuator, for example, the grommet depicted in the exemplary embodiment in FIG. 3. In embodiments, the kit comprises a thumbscrew assembly that is configured to anchor the actuator assembly, for example, the thumbscrew assembly depicted in the exemplary embodiment in FIG. 4. FIG. 5 illustrates an exemplary embodiment of a grommet 100 that is inserted into an actuator. In embodiments, the kit contains several grommets with varying diameters that tailor to different end-pin diameters.

In an aspect, a kit is provided comprising an actuator; and at least one device configured to secure the actuator against an end-pin of an upright musical instrument. In some embodiments, the at least one device comprises a thumbscrew assembly. In some embodiments, the at least one device comprises a clip. In some embodiments, the at least one device secures the actuator to any portion of the end-pin. In some embodiments, the at least one device secures the actuator to the end-pin near a floor/ground or a surface. In some embodiments, the at least one device secures the actuator to the end-pin near the base of the upright musical instrument. In some embodiments, the end-pin is permanently affixed to the actuator.

In some embodiments, the kit comprises at least one thumbscrew assembly and the at least one thumbscrew assembly comprises two thumbscrew assemblies. In some embodiments, each thumbscrew assembly comprises a hollow portion. In some embodiments, each thumbscrew assembly comprises a hollow portion with a different diameter relative to the other thumbscrew assembly.

In some embodiments, the kit further comprises the end-pin of the upright musical instrument. In some embodiments, the kit further comprises a grommet configured to be inserted into the hollow center of the actuator.

In an aspect, a kit is provided comprising an actuator comprising a hollow center; and at least one thumbscrew assembly comprising a hollow portion, wherein the at least one thumbscrew assembly is configured to secure the actuator against an end-pin of an upright musical instrument.

### Methods

In an aspect a method of actuating an upright musical instrument is provided comprising connecting an end-pin of the upright musical instrument to an actuator and securing the actuator to the end-pin. In some embodiments, the actuator is secured to the end-pin using at least one thumbscrew assembly. In some embodiments, the at least one thumbscrew assembly comprises a hollow portion configured to allow insertion of the end-pin into the thumbscrew assembly. In some embodiments, securing the actuator to the end-pin results in permanently affixing the actuator to the end-pin.

In some embodiments, the actuator comprises an upper portion and a lower portion. In some embodiments, the at least one thumbscrew assembly comprises two thumbscrew assemblies. In some embodiments, one of the thumbscrew assemblies secures the upper portion of the actuator to the end-pin. In some embodiments, one of the thumbscrew assemblies secures the lower portion of the end-pin to the actuator.

In some embodiments, the actuator is secured to the end-pin using at least one clip. In some embodiments, the at least one clip comprises two clips. In some embodiments, one of the at least two clips secures the upper portion of the actuator to the end-pin. In some embodiments, one of the at least two clips secures the lower portion of the actuator to the end-pin. In some embodiments, the actuator is secured to the end-pin using a clamp. In some embodiments, the clamp is a strut-mount clamp.

In an aspect, a method of actuating an upright musical instrument is provided, comprising threading an end-pin of the upright musical instrument through a hollow center of an actuator; and threading the end-pin of the upright musical instrument through a hollow portion of at least one thumbscrew assembly, to secure the actuator to the end-pin.

While various illustrative examples are described above, it will be apparent to one skilled in the art that various changes and modifications may be made therein without departing from the disclosure. It is to be understood that any respective features/examples of each of the aspects of the disclosure as described herein may be implemented together in any appropriate combination, and that any features/examples from any one or more of these aspects may be implemented together with any of the features of the other aspect(s) as described herein in any appropriate combination to achieve the benefits as described herein.

What is claimed is:

1. A kit, comprising:
an actuator; and
at least one thumbscrew assembly, at least one clip, or at least one clamp,
wherein the at least one thumbscrew assembly, the at least one clip, or the at least one clamp is configured to secure the actuator against an end-pin of an upright musical instrument.

2. The kit of claim 1, further comprising the end-pin of the upright musical instrument.

3. The kit of claim 1, further comprising a grommet configured to be inserted into a hollow center of the actuator.

4. The kit of claim 3, wherein the grommet comprises a lip that protrudes from the bottom of the grommet that is configured to cover a portion of the actuator.

5. The kit of claim 1, wherein the at least one thumbscrew assembly comprises at least two thumbscrew assemblies.

6. The kit of claim 1, wherein the at least clamp comprises at least one strut-mount clamp.

7. The kit of claim 1, wherein the at least one thumbscrew assembly comprises a hollow portion configured to allow insertion of the end-pin into the at least one thumbscrew assembly.

8. A composition, comprising:
an end-pin of an upright musical instrument; and
an actuator,
wherein the end-pin is in contact with the actuator.

9. The composition of claim 8, further comprising at least one thumbscrew assembly, at least one clip, or at least one clamp that secures the end-pin to the actuator.

10. The composition of claim 9, wherein the at least one clamp comprises at least one strut-mount clamp.

11. The composition of claim 8, wherein the end-pin is in contact with the actuator via threading the end-pin through a hollow center of the actuator.

12. The composition of claim 11, further comprising a grommet inserted into the hollow center of the actuator, wherein the grommet is configured to prevent vibration or rattling of the end-pin against the actuator.

13. The composition of claim 12, wherein the grommet comprises a lip that protrudes from a lower portion of the grommet that covers a portion of the actuator.

14. The composition of claim 9, wherein the actuator is contained within an enclosed structure, and wherein the at least one thumbscrew assembly, the at least one clip, or the at least one clamp secures the end-pin to the actuator via securing the enclosed structure to the end-pin.

15. The composition of claim 8, wherein the end-pin is permanently affixed to the actuator.

16. A method of actuating an upright musical instrument, comprising connecting an end-pin of the upright musical instrument to an actuator.

17. The method of claim 16, wherein the end-pin is connected to the actuator using a thumbscrew assembly, a clip, or a clamp.

18. The method of claim 16, wherein connecting the end-pin to the actuator results in permanently affixing the actuator to the end-pin.

19. The method of claim 16, further comprising a thumbscrew assembly, wherein the thumbscrew assembly comprises a hollow portion, wherein the end-pin is connected to the thumbscrew assembly through insertion of the end-pin into the hollow portion of the thumbscrew assembly.

20. The method of claim 17, wherein the clamp comprises a strut-mount clamp.
